(19) United States
(12) Patent Application Publication
(10) Pub. No.: US 2006/0021192 A1
(43) Pub. Date: Feb. 2, 2006

(54) Hinge device for a door leaf

(76) Inventor: Rene Gumbau, Nice (FR)

Correspondence Address: YOUNG & THOMPSON, 745 SOUTH 23RD STREET, 2ND FLOOR, ARLINGTON, VA, 22202, US

(21) Appl. No.: 10/531,595

(22) PCT Filed: Mar. 11, 2003
(86) PCT No.: PCT/EP03/02463

§ 371 Date: Apr. 18, 2005

(30) Foreign Application Priority Data
Oct. 17, 2002 (FR) 0212901

(51) Int. Cl. E05D 15/06

(52) U.S. Cl. 16/87 R

(57) ABSTRACT

The invention relates to a hinge device which is used to join the leaf (2) of a door (1) to the frame (3) thereof. The inventive device comprises at least one connecting rod (4, 5) which is mounted to rotate in relation to the frame and in relation to the leaf (2); and a carriage (7) which is mounted to move in translation widthwise in a guide which is solidly connected to the frame (3) and in rotation in relation to the leaf (2). According to the invention, the device comprises at least one rolling member between the carriage (7) and the lateral wall of the guide. The invention can be used to produce doors which combine a rotational and translational movement when being opened and closed.

The present invention relates to a hinge device used to join a door leaf to its frame.

The invention will find applications in the field of door construction and the use of doors with an opening and closing movement combined with a translational and rotational movement.

Door mechanisms presenting a combination of translational movement and rotational movement are already known.

Publication EP-A-674 077 is one illustration of this. This document describes a door leaf equipped with a pair of connecting rods assembled in rotation on the leaf and on the frame of the door. Moreover, a translational system equips the mechanism at the door lintel allowing it to slide horizontally in a guide formed in the width of the opening. A carriage constitutes this translational device, this carriage being fitted so that it pivots at the top end of the door leaf.

This type of door has the advantage of improving the opening and closing of the door relative to conventional doors which only pivot on one of their edges. In particular, the door described in the invention has the advantage of limiting the space occupied by the door leaf during opening and closing movements.

Although giving satisfaction on this point, the hinge devices proposed until now have not given entire satisfaction. In particular, it is noted that a hard spot occurs during the opening movement. This hard spot is noted at the beginning of the movement and is caused by the fact that the translational carriage is subjected to a considerable transversal force which tends to oppose the start of its movement.

The user has to apply an additional force and this also necessitates ensuring that the door has sufficient mechanical strength, in particular by a vertical reinforcing member between the rotational axes of the connecting rods passing through the thickness of the door leaf.

The present invention overcomes this disadvantage and to do so proposes a new hinge device for joining a door leaf to its frame.

In this context, the purpose of the present invention is to ensure very fluid movement of the carriage thereby facilitating the door opening and closing phases and requiring only the application of a constant and moderate force by the user. This point is particularly important insofar as this type of door can be used in particular to equip premises used by handicapped persons or moving on wheelchairs.

Other uses and advantages will appear during the description which follows, which presents a preferred embodiment of the invention without however this being restrictive.

The present invention relates to a hinge device which is used to join the leaf of a door to the frame thereof, including:

at least one connecting rod which is mounted to rotate in relation to the frame and in relation to the leaf.

a carriage which is mounted to move in translation widthwise in a guide which is solidly connected to the frame and in rotation relative to the door leaf.

It comprises at least one rolling member between the carriage and the lateral wall of the guide.

This device may take the form of the preferred alternatives listed below:

The rolling member is a wheel assembled to pivot on the carriage and able to come into contact with the lateral wall of the guide,

The wheel is mounted to pivot along the same axis as the carriage rotational axis in relation to the door leaf,

It includes a support structure solidly joined to the frame of the door, this structure including means for adjusting the height,

It includes two connecting rods, one situated in the top part of the leaf, the other in the bottom part.

The invention also relates to a door which is characterized by being equipped with at least one invention device.

The drawings attached are given as examples of the invention and are not restrictive. They represent only one embodiment of the invention and will enable it to be easily understood.

FIG. 1 is a general view of a door subject of the invention with two leaves.

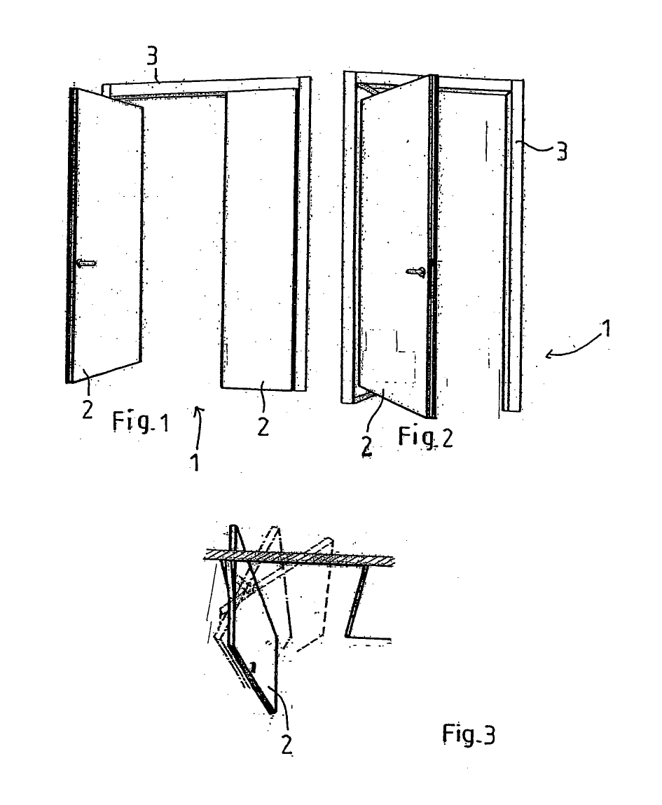

FIG. 2 is another embodiment with only one leaf.

FIG. 3 is a view in perspective of a door schematizing various phases of door leaf opening.

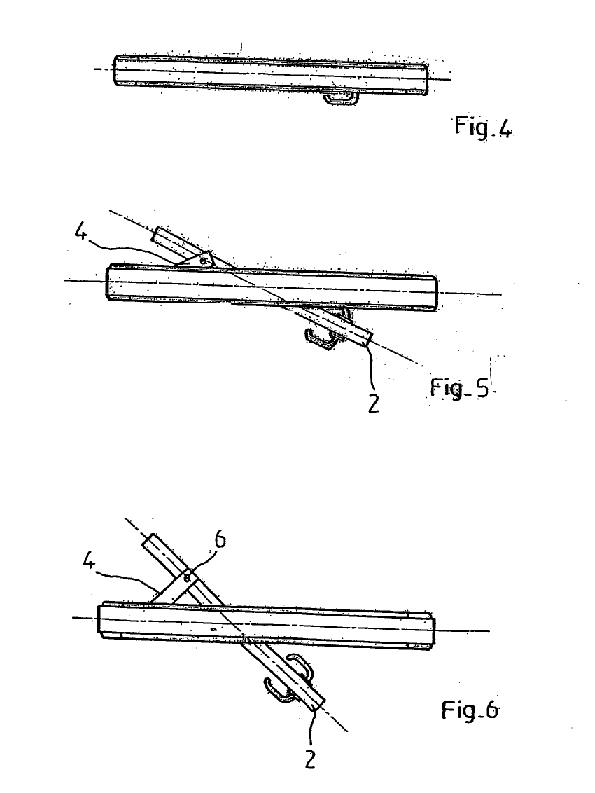

FIGS. 4 to 6 show successively three door opening phases from a completely closed phase to a more advanced open phase.

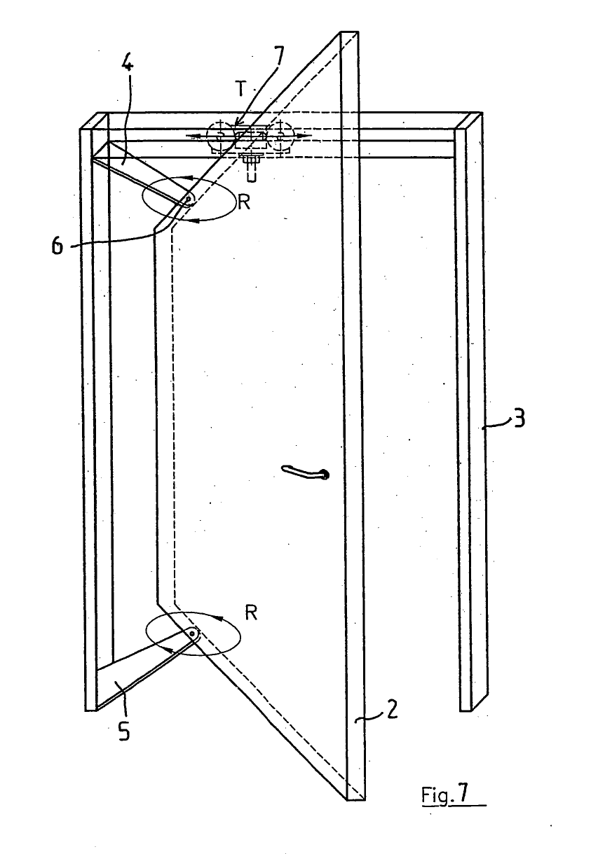

FIG. 7 is a general view of the invention device.

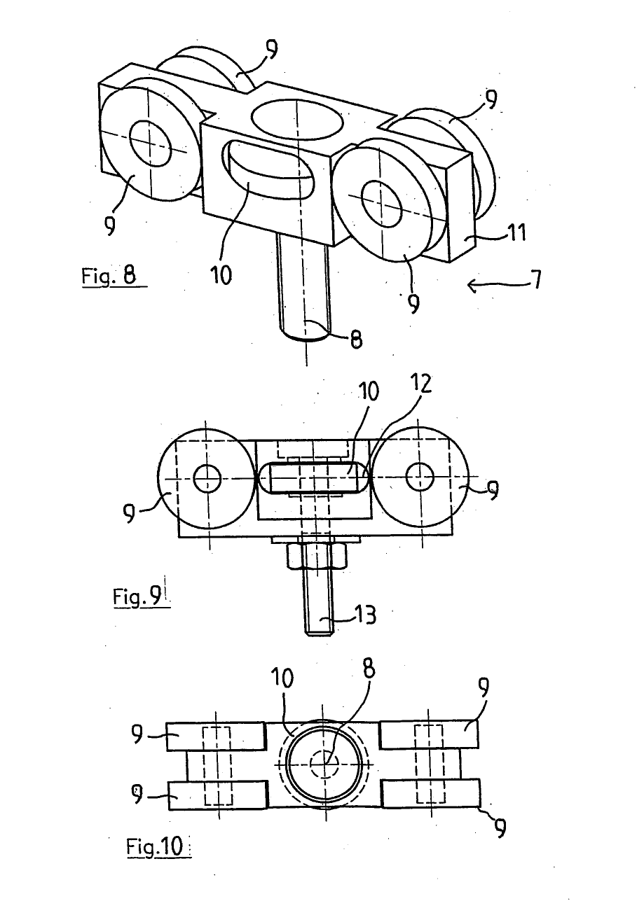

FIGS. 8 and 10 more particularly illustrate a preferred embodiment of the carriage.

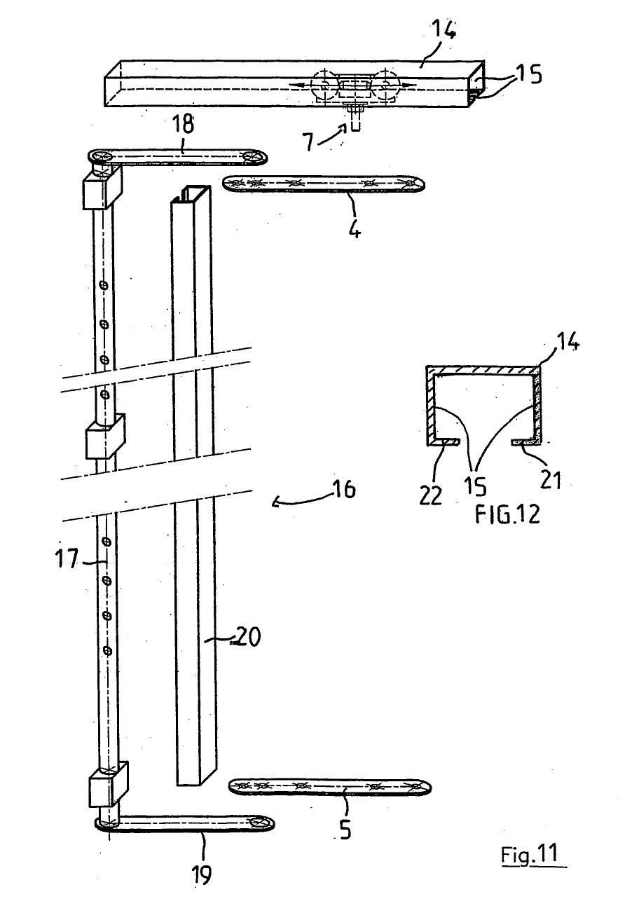

FIG. 11 is an exploded view of an embodiment of the invention.

FIG. 12 is a cross section view of a possible embodiment of a guide for the carriage.

The invention may be used on all types of door 1 and in particular doors with one or several leaves 2, such as shown on FIGS. 1 and 2.

The term <<door>> also covers in the broad sense any closing or opening device, including windows.

In a preferred arrangement, the invention can be fitted on a frame 3 of usual design equipping an opening.

FIG. 3 is an example of the evolving position of a door leaf 2 when opening. It is noted that the space swept by leaf 2 during opening is less than the space that will be swept by a door which is only pivoting.

This observation is also apparent on FIGS. 4 to 6 which show a top view translational movement and a rotational movement through a system of connecting rods is noted.

More precisely, by referring to FIG. 7, it can be seen that the invention may have one or preferably two connecting rods 4 and 5, located at the top and bottom of leaf 2 of door 1. At one of their ends, connecting rods 4, 5 are assembled so as to rotate on leaf 2. At the other end, they are assembled so as to rotate in relation to frame 3 of door 1. The axis of rotation of connecting rods 4, 5 in relation to leaf 2 is shown as item 6, especially on FIGS. 6 and 7.

This system of connecting rods ensures the rotational movement of leaf 2 in relation to frame 3, as indicated by the arrows close to the letters R on FIG. 7.

Widthwise translation in frame 3, in this case at lintel level, also takes place as shown by the arrow T in FIG. 7.

This translational movement is generated according to the invention by a carriage 7 fitted to slide in a guide 14 solidly joined widthwise to frame 3. Moreover, carriage 7 is mounted to rotate in relation to leaf 2 so as not to hamper the rotational movement of leaf 2 in relation to frame 3.

It can be easily understood that carriage 7 is able to absorb a considerable share of the forces applied to the door and in particular the weight of leaf 2 itself.

It can be easily understood that the inertia of the system as well as friction of the parts in relative movement have to be overcome when opening the door. In addition, the force applied by the user when the door is closed includes a high transversal component (here meaning the direction created by the thickness of the door). Therefore, starting the translational movement of carriage 7 in door 1 widthwise direction is resisted by the orientation of the force applied by the user at the start of movement.

In order to help start the opening movement and to avoid any hard spots, the invention has the advantage of including at least one rolling member placed between carriage 7 and lateral wall 15 of guide 14.

FIG. 12 shows an embodiment of guide 14 in cross section. In this case, lateral walls 15 are shown as constituting the two lateral vertical surfaces of guide 14.

As a preferred arrangement, the rolling member is a wheel 10 fitted to pivot on carriage 7 and with the capacity to come into contact with one of the lateral walls 15 of guide 14.

Thus, during operation of the door, the force applied by the user will tend to bring carriage 7 into contact with one of the lateral walls 15. At this instant, wheel 10 comes into contact with the lateral wall in question which causes rotational movement of the aforesaid wheel. This rotation avoids any blocking or hardness of the system.

In a preferred arrangement, the rotational axis of wheel 10 is identical to the rotational axis of carriage 7 in relation to leaf 2 of door 1.

This axis 8 is in particular shown on FIGS. 8 and 10.

An example of the construction of carriage 7 is given below with reference to FIGS. 8 to 10. These figures show that carriage 7 can have multiple wheels 9 whose axis of rotation is here shown oriented in a horizontal direction. Wheels 9 are in contact with guide 14 on two rolling surfaces 21, 22 shown in FIG. 12. Wheels 9 are rotated on translation of carriage 7 in guide 14. Wheels 9 are supported by support 11 which allows them to pivot. Support 11 also allows rotational assembly of wheel 10, in a transversal direction to wheels 9, this direction being roughly vertical.

Wheel 10 is best fitted on leaf 2 concomitantly with carriage 7 using a bolted rod 13.

FIG. 11 shows an embodiment of a full hinge device according to the invention. A support structure 16 is shown which initially includes an upright 17 capable of being adjusted to the height of door 1. Any adjustment means can be used, including for example a system of co-acting sliding tubes with means for stopping the translational movement. The structure of support 16 can also include a pair of angles 18, 19 at the top and bottom of the door and capable of resting on the widthwise circumference of the opening. In order to constitute a system adaptable to all types of openings and applicable in restoration work, the structure of support 16 is equipped with a cover 20 masking the structural and functional elements of the device.

In view of the rolling movement produced by carriage 7 on the lateral wall of guide 15, it is observed surprisingly that the force required to open or close door 1 is perfectly continuous. Therefore, the user is not required to exert a considerable force and this reduces the range of forces that the door has to withstand. In particular, in view of the limited forces needed to open and close door 1 of the invention, there is no need to envisage fitting a stiffening member to leaf 2 of the door, which has hitherto generally been necessary and which has been positioned vertically in order to join the axes of pivot 6 of the upper and lower connecting rods passing through leaf 2.

The result is a wider choice for the construction of leaves 2. For example these could consist of glass or other transparent material, and this increases the application of the type of door covered by the invention.

### REFERENCES

1. Door
2. Leaf
3. Frame
4. Upper connecting rod
5. Lower connecting rod
6. Axis of rotation
7. Carriage
8. Axis of rotation
9. Wheels of translational movement
10. Wheel
11. Support
12. Housing
13. Rod
14. Guide
15. Lateral wall
16. Structure of support
17. Adjustable upright
18. Upper angle
19. Lower angle
20. Cover
21. Rolling surface
22. Rolling surface

1-6. (canceled)

7. Hinge device used to join leaf (2) of a door (1) to frame (3) thereof, including:
at least one connecting rod (4, 5) which is mounted to rotate in relation to the frame and in relation to leaf (2).
a carriage (7) which is mounted to move in translation widthwise in a guide (14) which is solidly connected to frame (3), and in rotation relative to the door leaf (2), carriage (7) has multiple wheels (9) the axis of rotation of which is oriented horizontally and applies on guide (14),
characterized in that
It comprises at least one rolling member between carriage (7) and lateral wall (15) of guide (14).

8. Device according to claim 7,
characterized in that
the rolling member is a wheel (10) fitted to pivot on carriage (7) and capable of coming into contact with lateral wall (15) of guide (14).

9. Device according to claim 8,
characterized in that
Wheel (10) is assembled to pivot on the same axis (8) as the rotational axis of carriage (7) in relation to leaf (2).

10. Device according to claim 7,
characterized in that
it includes a support structure (16) that can be solidly joined to frame (3) of door (11), this structure (16) including means for adjusting its height.

11. Device according to claim 7,
characterized in that
it includes two connecting rods (4, 5), one located in the upper part of the leaf, the other in the lower part.

12. Door (1),
characterized in that it is equipped with at least one device according to claim 7.

13. Device according to claim 8,
characterized in that
it includes a support structure (16) that can be solidly joined to frame (3) of door (11), this structure (16) including means for adjusting its height.

14. Device according to claim 9,
characterized in that
it includes a support structure (16) that can be solidly joined to frame (3) of door (11) this structure (16) including means for adjusting its height.

15. Device according to claim 8,
characterized in that
it includes two connecting rods (4, 5), one located in the upper part of the leaf, the other in the lower part.

16. Device according to claim 9,
characterized in that
it includes two connecting rods (4, 5), one located in the upper part of the leaf, the other in the lower part.

17. Device according to claim 10,
characterized in that
it includes two connecting rods (4, 5), one located in the upper part of the leaf, the other in the lower part.

18. Door (1),
characterized in that it is equipped with at least one device according to claim 8.

19. Door (1),
characterized in that it is equipped with at least one device according to claim 9.

20. Door (1),
characterized in that it is equipped with at least one device according to claim 10.

21. Door (1),
characterized in that it is equipped with at least one device according to claim 11.
